(19) United States
(12) Patent Application Publication
(10) Pub. No.: US 2025/0353723 A1
(43) Pub. Date: Nov. 20, 2025

(54) TOP-LOADED WATER DISPENSER

(71) Applicants: FOSHAN SHUNDE MIDEA WATER DISPENSER MANUFACTURING CO., LTD., Foshan (CN); MIDEA GROUP CO., LTD., Foshan (CN)

(72) Inventors: Sipei Hong, Foshan (CN); Baoyou Cheng, Foshan (CN)

(73) Assignees: FOSHAN SHUNDE MIDEA WATER DISPENSER MANUFACTURING CO., LTD., Foshan (CN); MIDEA GROUP CO., LTD., Foshan (CN)

(21) Appl. No.: 18/999,524

(22) Filed: Dec. 23, 2024

Related U.S. Application Data
(63) Continuation of application No. PCT/CN2024/126161, filed on Oct. 21, 2024.

(30) Foreign Application Priority Data
May 15, 2024 (CN) 202410607655.9
May 15, 2024 (CN) 202421064318.1
May 15, 2024 (CN) 202421065467.X
May 15, 2024 (CN) 202421065916.0

(51) Int. Cl. B67D 1/00; B67D 1/08

(52) U.S. Cl. CPC B67D 1/0014; B67D 1/0858; B67D 1/0895; B67D 2001/0095; B67D 2210/00049; B67D 2210/0006

(57) ABSTRACT

A top-loaded water dispenser is provided. The top-loaded water dispenser includes a first manifold having a water receiving basin, a water inlet passageway, and a water outlet passageway; a second manifold having a drainage passageway; a cooling tank adapted to be in communication with the water inlet passageway to receive water from the water receiving basin, adapted to be in communication with the water outlet passageway to output refrigerated water, and further adapted to be in communication with the drainage passageway to drain the water in the cooling tank; and a heating tank adapted to be in communication with the water inlet passageway to receive the water from the water receiving basin, adapted to be in communication with the water outlet passageway to output heated water, and further adapted to be in communication with the drainage passageway to drain the water in the heating tank.

### CROSS-REFERENCE TO RELATED APPLICATIONS

This application is a continuation of International Application No. PCT/CN2024/126161, filed on Oct. 21, 2024, which claims priorities to Chinese Patent Application No. 202410607655.9, entitled “TOP-LOADED WATER DISPENSER” and filed on May 15, 2024, Chinese Patent Application No. 202421065916.0, entitled “DISPENSER” and filed on May 15, 2024, Chinese Patent Application No. 202421064318.1, entitled “TOP-LOADED WATER DISPENSER” and filed on May 15, 2024, and Chinese Patent Application No. 202421065467.X, entitled “TOP-LOADED WATER DISPENSER” and filed on May 15, 2024, the entire contents of each of which are hereby incorporated by reference. No new matter has been introduced.

### FIELD

The present disclosure relates to the technical field of drinking water and water-using devices, and in particular, to a top-loaded water dispenser.

### BACKGROUND

Some top-loaded water dispensers have the functionality to dispense normal temperature water, cold water, and hot water, which needs to be realized through a plurality of components within the top-loaded water dispenser. For example, the top-loaded water dispenser is internally provided with a cooling tank, a heating tank, and the like. Because the top-loaded water dispenser is internally provided with the plurality of components, in order to realize communication between passageways of different components, a large number of silicone tubes are used in the related art to realize a connection and communication of the different components. The silicone tubes are prone to producing peculiar odors and are susceptible to fracturing, resulting in a water leakage. Additionally, during the factory assembly process, workers are required to connect the silicone tubes individually, resulting in low production efficiency.

### SUMMARY

To achieve the above purpose, the present disclosure discloses a top-loaded water dispenser. The top-loaded water dispenser includes: a first manifold having a water receiving basin, a water inlet passageway, and a water outlet passageway; a second manifold having a drainage passageway; a cooling tank adapted to be in communication with the water inlet passageway to receive water from the water receiving basin, adapted to be in communication with the water outlet passageway to output refrigerated water, and further adapted to be in communication with the drainage passageway to drain the water in the cooling tank; and a heating tank adapted to be in communication with the water inlet passageway to receive the water from the water receiving basin, adapted to be in communication with the water outlet passageway to output heated water, and further adapted to be in communication with the drainage passageway to drain the water in the heating tank.

Other advantages of the present disclosure will be in part set forth below, become apparent in part from the following description, or can be learned by practice of the present disclosure.

### BRIEF DESCRIPTION OF THE DRAWINGS

In order to clearly explain technical solutions of the embodiments of the present disclosure or in the prior art, accompanying drawings needing to be used in the description of the embodiments or the prior art are briefly described below. Obviously, the accompanying drawings as described below are merely some embodiments of the present disclosure. Based on structures illustrated in these drawings, other designs can be obtained by those of ordinary skill in the art without creative efforts.

FIG. 1 is a schematic view of a top-loaded water dispenser in some embodiments.

FIG. 2 is a schematic assembly view of a top-loaded water dispenser in some embodiments.

FIG. 3 is a partially schematic structural view of a top-loaded water dispenser in some embodiments.

FIG. 4 is an enlarged view at part A labeled in FIG. 3.

FIG. 5 is an exploded view of a top-loaded water dispenser in some embodiments.

FIG. 6 is an assembly view of a support, a first manifold, a second manifold, a cooling tank, a heating tank, a compressor, and a condenser in some embodiments.

FIG. 7 is a schematic view of a structure illustrated in FIG. 6 from another angle.

FIG. 8 is an exploded view of a structure illustrated in FIG. 6.

FIG. 9 is a schematic view of a first manifold in some embodiments.

FIG. 10 is a schematic view of a first manifold in some embodiments (with a viewing angle different from a viewing angle of FIG. 9).

FIG. 11 is a schematic view of a first manifold in some embodiments (with a viewing angle different from a viewing angle of each of FIG. 9 and FIG. 10).

FIG. 12 is a schematic view of a first manifold in some embodiments (with a viewing angle same as a viewing angle of FIG. 11, identifying a first connection portion and a fifth connection portion);

FIG. 13 is a schematic view of a second manifold in some embodiments.

FIG. 14 is a schematic view of a second manifold in some embodiments (with a viewing angle different from a viewing angle of FIG. 13).

FIG. 15 is a schematic view of a heating tank in some embodiments.

FIG. 16 is a schematic view of a cooling tank in some embodiments.

FIG. 17 is a schematic view of a top structure of a cooling tank in some embodiments.

FIG. 18 is a schematic view of a three-way pipe in some embodiments.

FIG. 19 is a schematic view of cooperation of two connected components in an insertion manner (the two connected in the insertion manner) with a sealing member in some embodiments.

FIG. 20 is a schematic view of a sealing member in some embodiments.

FIG. 21 is a passageway diagram of a top-loaded water dispenser in some embodiments.

### DESCRIPTION OF REFERENCE NUMERALS

water bucket 10, housing 1000, body 1001, bottom plate 1002, storage space 1003, partition 1004, through hole 1005, upper cover 1010, avoidance hole 1011, first side plate 1020, second side plate 1030, front housing 1040, hook slot 1050, support 1100, hook 1110, smart base 1200, openable/closable door 1300, water collection box 1400, hot water faucet 2200, cold water faucet 2100, normal temperature water faucet 2300, first manifold 3000, water receiving basin 3100, first partitioning member 3110, second partitioning member 3120, first exhaust region 3130, second exhaust region 3140, water inlet passageway 3200, first water inlet passageway 3210, first water inlet connector 3211, second water inlet passageway 3220, second water inlet connector 3221, water outlet passageway 3300, first water outlet passageway 3310, first water outlet connector 3311, second water outlet passageway 3320, second water outlet connector 3321, third water outlet passageway 3330, first water outlet 3340, second water outlet 3350, third water outlet 3360, exhaust passage 3400, first air passage 3410, first exhaust connector 3411, second air passage 3420, second exhaust connector 3421, first connection portion 3510, fifth connection portion 3520, second manifold 4000, drainage passageway 4100, first drainage passageway 4110, first drainage connector 4111, second drainage passageway 4120, second drainage connector 4121, second connection portion 4200, cooling tank 5000, cooling-tank water inlet connector 5100, cooling-tank water outlet connector 5200, cooling-tank drainage connector 5300, cooling-tank exhaust connector 5400, compressor 5500, third connection portion 5610, fourth connection portion 5620, condenser 5700, heating tank 6000, heating-tank water inlet and drainage connector 6100, heating-tank water outlet connector 6200, heating-tank exhaust connector 6300, sixth connection portion 6400, three-way pipe 7000, first end 7100, second end 7200, third end 7300, sealing member 8000, first annular wall 8100, second annular wall 8200, and sandwiched cavity 8300.

Implementation, functional characteristics, and advantages of the present disclosure will be further described in combination with the embodiments with reference to the drawings.

### DETAILED DESCRIPTION

Technical solutions according to embodiments of the present disclosure will be described clearly and completely below in combination with accompanying drawings of the embodiments of the present disclosure. Obviously, the embodiments described below are only a part of the embodiments of the present disclosure, rather than all embodiments of the present disclosure. Based on the embodiments of the present disclosure, all other embodiments obtained by those skilled in the art without creative labor shall fall within the scope of the present disclosure.

It should be noted that all orientation terms in the embodiments of the present disclosure (such as over, below, left, right, front, rear, or the like) are only used to explain relative positional relationships and movements between all components under a specific posture (as illustrated in the drawings). When the specific posture changes, the orientation terms also change correspondingly.

In the present disclosure, unless otherwise clearly specified and limited, terms such as “connected to”, “fixed”, and the like should be understood in a broad sense. For example, unless otherwise clearly specified and limited, “fixed” may be a fixed connection or a detachable connection or connection as one piece; mechanical connection or electrical connection; direct connection or indirect connection through an intermediate; internal communication of two components or the interaction relationship between two components. For those of ordinary skill in the art, the specific meanings of the above terms in the present disclosure can be interpreted depending on specific situations.

In addition, the term such as “first” or “second” in the present disclosure is only for descriptive purposes, rather than indicating or implying relative importance or implicitly indicating the number of indicated technical features. Therefore, the features associated with “first” or “second” can explicitly or implicitly include at least one of the features. In addition, the technical solutions between various embodiments may be combined with each other, but it must be based on the premise that those skilled in the art can implement them. When the combination of the technical solutions contradicts each other or is unachievable, it should be considered that the combination of the technical solutions does not exist, nor is within the scope of the present disclosure.

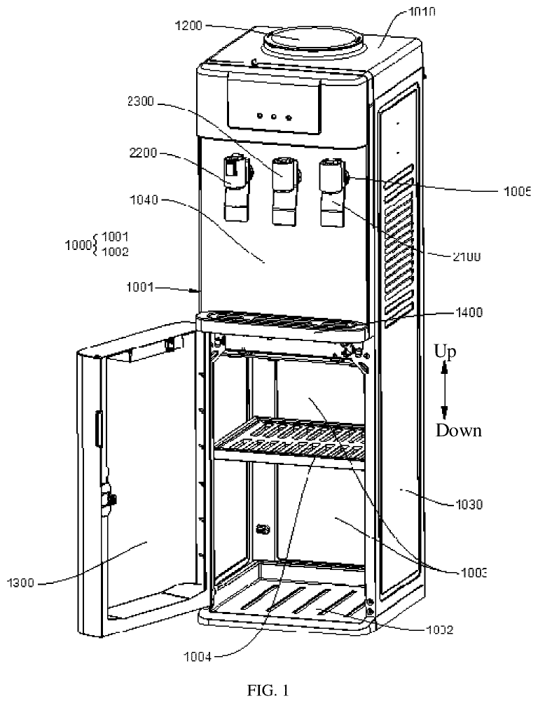

As illustrated in FIG. 1 to FIG. 8, in some embodiments, the top-loaded water dispenser includes a first manifold 3000, a second manifold 4000, a cooling tank 5000, and a heating tank 6000. The first manifold 3000 has a water outlet passageway 3300, a water inlet passageway 3200, and a water receiving basin 3100. The second manifold 4000 has a drainage passageway 4100. The cooling tank 5000 is used for being in communication with the water inlet passageway 3200, the water outlet passageway 3300, and the drainage passageway 4100. In this way, water from the water receiving basin 3100 can be received through the water inlet passageway 3200, refrigerated water can be outputted through the water outlet passageway 3300, and water in the cooling tank 5000 is drained through the drainage passageway 4100. The heating tank 6000 is used for being in communication with the water inlet passageway 3200, the water outlet passageway 3300, and the drainage passageway 4100. In this way, the water from the water receiving basin 3100 can be received through the water inlet passageway 3200, heated water can be outputted through the water outlet passageway 3300, and water in the heating tank 6000 is drained through the drainage passageway 4100.

The first manifold 3000 and the second manifold 4000 may be used as core components to be connected to the cooling tank 5000 and the heating tank 6000, facilitating passageway communication. Each of the first manifold 3000 and the second manifold 4000 has corresponding passageways, which replace silicone tubes in a traditional top-loaded water dispenser, reduce use of the silicone tubes, effectively avoid occurrence of a water leakage problem, and is more conducive to modular assembly, thereby improving production efficiency.

The first manifold 3000 includes the water receiving basin 3100, the water inlet passageway 3200, and the water outlet passageway 3300. The water receiving basin 3100 is a component for temporarily storing a predetermined amount of water. The so-called top-loaded water dispenser, i.e., a water bucket 10 needs to be loaded inversely, allowing water in the water bucket 10 to enter the water receiving basin 3100 under action of gravity. For example, this can be achieved by providing a smart base 3100. The smart base 1200 of the top-loaded water dispenser is loaded in the water receiving basin 3100, and the water bucket 10 is inversely loaded on the smart base 1200. In this way, the water in the water bucket 10 enters the water receiving basin 3100 without overflowing. Cooperation among the water receiving basin 3100, the smart seat 1200, and the water bucket 10 may be referred to the related technology, and details are omitted herein. In this embodiment, the smart base 1200 may be designed to be detachably arranged relative to the water receiving basin 3100. In this way, manufacturing difficulty is reduced, and cleaning is facilitated.

The cooling tank 5000 is in communication with the water inlet passageway 3200 and the water outlet passageway 3300, and is used for refrigerating water entering the cooling tank 5000, which may be referred to the related technology. When the top-loaded water dispenser is required to output cold water for a user to drink, a cold water faucet 2100 is turned on, the water in the water receiving basin 3100 flows into the cooling tank 5000 through the water inlet passageway 3200 and is cooled into cold water, and the cold water flows to the cold water faucet 2100 through the water outlet passageway 3300 and finally is outputted from the cold water faucet 2100. The cooling tank 5000 is in communication with the drainage passageway 4100. When it is necessary to clean the cooling tank 5000 and passageways in communication with the cooling tank 5000 (the passageways, i.e., a passage through which the water is supplied and flows, including the water inlet passageway 3200, the water outlet passageway 3300, and/or the drainage passageway 4100), the water in the cooling tank 5000 may be drained from the cooling tank 5000 and drained to an outside through the drainage passageway 4100. For example, the drainage passageway 4100 is provided with a corresponding valve or a soft plug. The water in the cooling tank 5000 may be drained to the outside through the drainage passageway 4100 by opening the valve or the soft plug. When the valve or the soft plug is in a closed state, the water in the cooling tank 5000 may not be drained to the outside through the drainage passageway 4100.

The heating tank 6000 is in communication with the water inlet passageway 3200 and the water outlet passageway 3300, and is used for heating water entering the heating tank 6000, which may be referred to the related technology. When the top-loaded water dispenser is required to output hot water for the user to drink, a hot water faucet 2200 is turned on, the water in the water receiving basin 3100 flows into the heating tank 6000 through the water inlet passageway 3200 and is heated into hot water, and the hot water flows to the hot water faucet 2200 through the water outlet passageway 3300 and finally is outputted from the hot water faucet 2200. The heating tank 6000 is in communication with the drainage passageway 4100. When it is necessary to clean the heating tank 6000 and a passageway in communication with the heating tank 6000, the water in the heating tank 6000 may be drained from the heating tank 6000 and drained to the outside through the drainage passageway 4100.

It can be understood that the cooling tank 5000 and the heating tank 6000 may share the water inlet passageway 3200, the water outlet passageway 3300, and/or the drainage passageway 4100, or may not share the water inlet passageway 3200, the water outlet passageway 3300, and/or the drainage passageway 4100.

The so-called manifold is a component integrated with corresponding passageways. The first manifold 3000 is integrated with the water inlet passageway 3200 and the water outlet passageway 3300. Functions of the water inlet passageway 3200 and the water outlet passageway 3300 are equivalent to the silicone tube in the traditional top-loaded water dispenser. Since the water inlet passageway 3200 and the water outlet passageway 3300 are integrated on the first manifold 3000, the first manifold 3000 has a structural strength much greater than a structural strength of a single silicone tube and is not easy to fracture. Therefore, a problem of fracture and water leakage is effectively avoided. Similarly, for the second manifold 4000, the drainage passageway 4100 is integrated on the second manifold 4000 and is also equivalent to the silicone tube in the traditional top-loaded water dispenser. Since the drainage passageway 4100 is integrated on the second manifold 4000, the second manifold 4000 has a structural strength much greater than the structural strength of the single silicone tube and is not easy to fracture. Therefore, the problem of fracture and water leakage is effectively avoided. For example, the first manifold 3000 and the second manifold 4000 may be made of hard materials (hard meaning they are not easy to deform, such as by hand), which not only makes the corresponding passageways less likely to fracture and leak water, but also plays a predetermined supporting role in installation of the cooling tank 5000 and the heating tank 6000. It is worth noting that the water in the water receiving basin 3100 is at a normal temperature, and feeding water of the cooling tank 5000 and feeding water of the heating tank 6000 come from the water receiving basin 3100. In this way, a problem of water cross-contamination between the cooling tank 5000 and the heating tank 6000 can be avoided, and thus it is beneficial to reduce cooling energy consumption and heating energy consumption.

When assembling the top-loaded water dispenser, the heating tank 6000 is assembled with the first manifold 3000 and the second manifold 4000, and the cooling tank 5000 is assembled with the first manifold 3000 and the second manifold 4000. Since the first manifold 3000 and the second manifold 4000 are respectively integrated with corresponding passageways, communication between the corresponding passageways may be realized only by assembling the cooling tank 5000 with the first manifold 3000 and the second manifold 4000 and by assembling the heating tank 6000 with the first manifold 3000 and the second manifold 4000, eliminating the need for workers to connect the silicone tubes one by one as in the related technology. The first manifold 3000 and the second manifold 3000 are highly integrated components, which is more beneficial to realization of automated production in factories and is beneficial to improving the production efficiency.

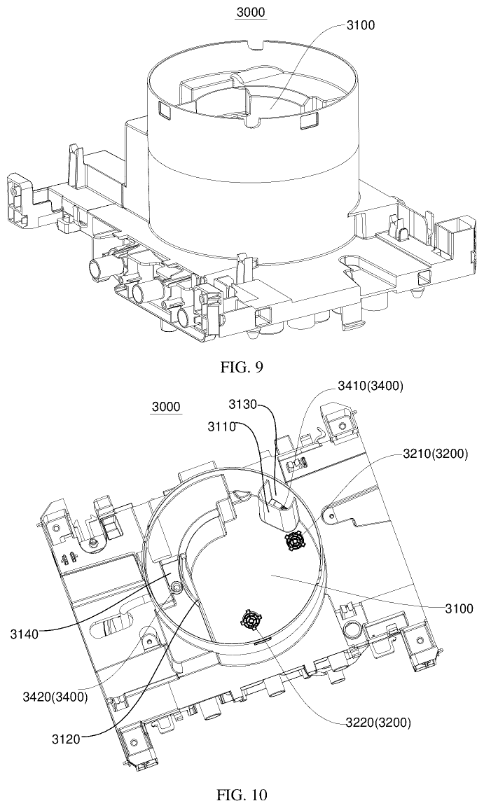

Passageways of the first manifold 3000 and the second manifold 4000 will be described in detail below. As illustrated in FIG. 9 to FIG. 14, in some embodiments, the water inlet passageway 3200 includes a first water inlet passageway 3210 and a second water inlet passageway 3220. The cooling tank 5000 is in communication with the first water inlet passageway 3210. The heating tank 6000 is in communication with the second water inlet passageway 3220. The water outlet passageway 3300 includes a first water outlet passageway 3310 and a second water outlet passageway 3320. The cooling tank 5000 is in communication with the first water outlet passageway 3310. The heating tank 6000 is in communication with the second water outlet passageway 3320. Since the cooling tank 5000 and the heating tank 6000 respectively occupy a predetermined space, by providing the first water inlet passageway 3210, the second water inlet passageway 3220, the first water outlet passageway 3310, and the second water outlet passageway 3320, the cooling tank 5000 and the heating tank 6000 may be made more flexible in spatial arrangement.

In an exemplary embodiment of the present disclosure, the first water inlet passageway 3210, the second water inlet passageway 3220, the first water outlet passageway 3310, and the second water outlet passageway 3320 are spaced apart from each other on the first manifold 3000. The first water inlet passageway 3210 is in communication with the water receiving basin 3100. The second water inlet passageway 3220 is in communication with the water receiving basin 3100. The cooling tank 5000 is in communication with the first water inlet passageway 3210 and the first water outlet passageway 3310. The heating tank 6000 is in communication with the second water inlet passageway 3220 and the second water outlet passageway 3320. The first water outlet passageway 3310 is connected to the cold water faucet 2100, and the second water outlet passageway 3320 is connected to the hot water faucet 2200.

When the top-loaded water dispenser is required to output the cold water for the user to drink, the cold water faucet 2100 is turned on, the water in the water receiving basin 3100 flows into the cooling tank 5000 through the first water inlet passageway 3210 and is cooled into the cold water, and the cold water flows to the cold water faucet 2100 through the first water outlet passageway 3310 and finally is outputted from the cold water faucet 2100. When the top-loaded water dispenser is required to output the hot water for the user to drink, the hot water faucet 2200 is turned on, the water in the water receiving basin 3100 flows into the heating tank 6000 through the second water inlet passageway 3220 and is heated into the hot water, and the hot water flows to the hot water faucet 2200 through the second water outlet passageway 3320 and finally is outputted from the hot water faucet 2200.

Similarly, the drainage passageway 4100 includes a first drainage passageway 4110 and a second drainage passageway 4120. The first drainage passageway 4110 is arranged corresponding to the cooling tank 5000 and in communication with the cooling tank 5000. The second drainage passageway 4120 is arranged corresponding to the heating tank 6000 and in communication with the heating tank 6000. By providing the first drainage passageway 4110 and the second drainage passageway 4120, drainage of the cooling tank 5000 and the heating tank 6000 may be controlled, respectively. The water in the cooling tank 5000 is drained to the outside through the first drainage passageway 4110, realizing cleaning. The water in the heating tank 6000 is drained to the outside through the second drainage passageway 4120, realizing the cleaning. The drainage of the cooling tank 5000 does not interfere with the drainage of the heating tank 6000.

Further, in some embodiments, the cooling tank 5000 is connected to the first manifold 3000 and the second manifold 4000 in an insertion manner, allowing the cooling tank 5000 to be in communication with the first water inlet passageway 3210, the first water outlet passageway 3310, and the first drainage passageway 4110. Assembly convenience is improved in the insertion manner.

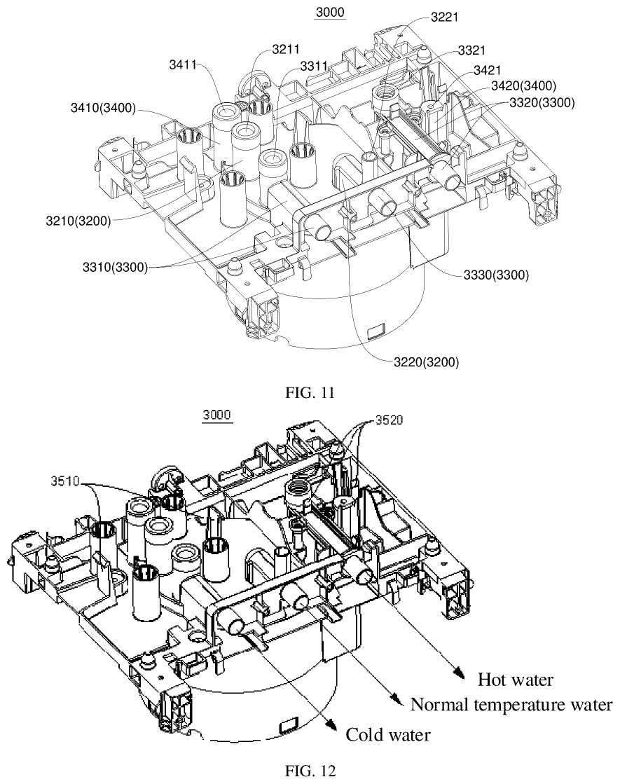

In an exemplary embodiment of the present disclosure, as illustrated in FIG. 11, FIG. 16, and FIG. 17, the cooling tank 5000 has a cooling-tank drainage connector 5300, a cooling-tank water outlet connector 5200, and a cooling-tank water inlet connector 5100. The cooling-tank drainage connector 5300 is located at a bottom of the cooling tank 5000. The cooling-tank water outlet connector 5200 and the cooling-tank water inlet connector 5100 are located at a top of the cooling tank 5000. The cooling-tank drainage connector 5300, the cooling-tank water outlet connector 5200, and the cooling-tank water inlet connector 5100 are in communication with an internal space of the cooling tank 5000, respectively. The first water inlet passageway 3210 has a first water inlet connector 3211 at an end of the first water inlet passageway 3210 and has another end in communication with the water receiving basin 3100. The first water outlet passageway 3310 has a first water outlet connector 3311 at an end of the first water outlet passageway 3310 and has another end connected to the cold water faucet 2100. The first drainage passageway 4110 has a first drainage connector 4111 at an end of the first drainage passageway 4110 and has another end in communication with the outside. Since the cold water sinks, the cooling-tank water inlet connector 5100 is connected with a cold water pipe extending to the bottom of the cooling tank 5000.

When the top-loaded water dispenser is assembled, the first water inlet connector 3211 is connected to the cooling-tank water inlet connector 5100 in an insertion manner to communicate the first water inlet passageway 3210 and the cooling tank 5000, allowing the water to flow from the first water inlet passageway 3210 into the cooling tank 5000. The first water outlet connector 3311 is connected to the cooling-tank water outlet connector 5200 in an insertion manner to communicate the cooling tank 5000 and the cold water faucet 2100, allowing the cold water to flow from the cooling tank 5000 to the cold water faucet 2100. The first drainage connector 4111 is connected to the cooling-tank drainage connector 5300 in an insertion manner to communicate the cooling tank 5000 and the outside, allowing the water to flow from the cooling tank 5000 to the outside. It can be understood that being connected in the insertion manner means that one of the components is inserted into another component. As an example, the first water inlet connector 3211 is connected to the cooling-tank water inlet connector 5100 in the insertion manner. The first water inlet connector 3211 may be inserted into the cooling-tank water inlet connector 5100, or the cooling-tank water inlet connector 5100 may be inserted into the first water inlet connector 3211. The same principle applies to other similar connections.

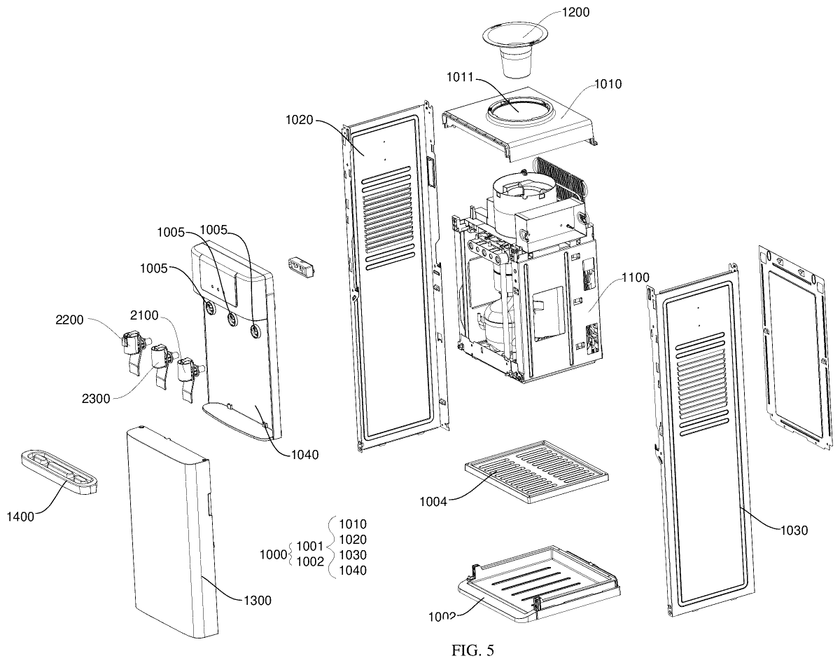

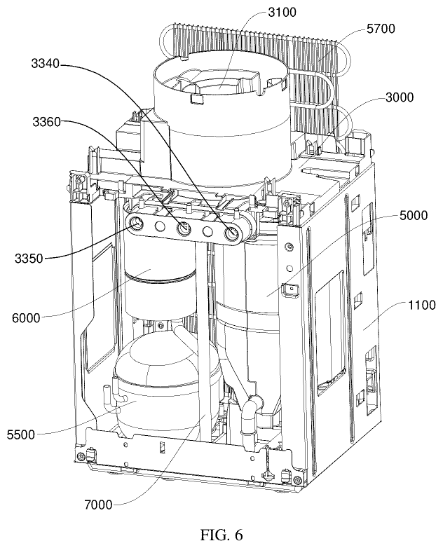

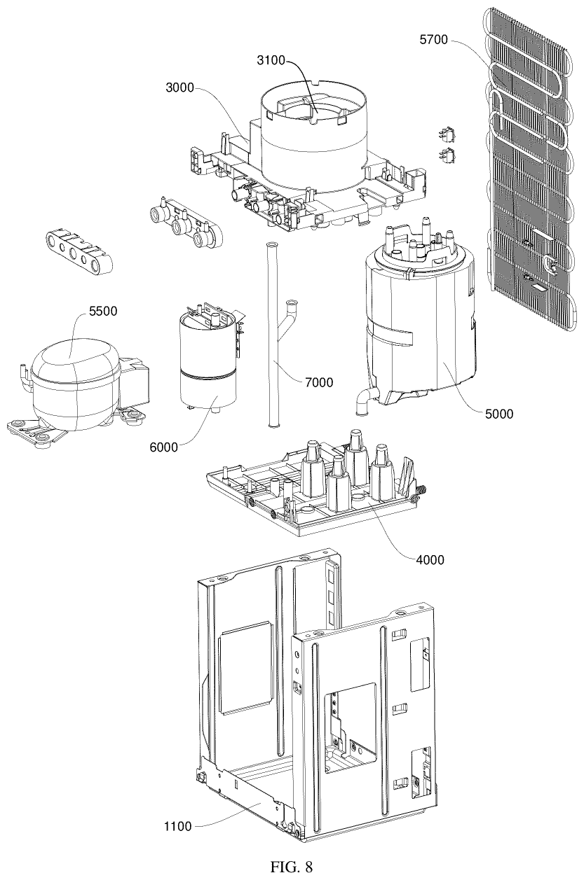

As illustrated in FIG. 6 and FIG. 8, in some embodiments, the top-loaded water dispenser includes a three-way pipe 7000 having three end portions, i.e., a first end 7100, a second end 7200, and a third end 7300, respectively. The first end 7100 is in communication with the second water inlet passageway 3220. The second end 7200 is in communication with the second drainage passageway 4120. The third end 7300 is in communication with the heating tank 6000. For example, the three-way pipe 7000 is made of hard materials.

When the top-loaded water dispenser is required to output the hot water for the user to drink, the hot water faucet 2200 is turned on, and the water in the water receiving basin 3100 flows into the three-way pipe 7000 (flows into the three-way pipe 7000 from the first end 7100) through the second water inlet passageway 3220, and flows out from the third end 7300 to enter the heating tank 6000 to be heated into the hot water (the second drainage passageway 4120 is in the closed state). The hot water flows through the second water outlet passageway 3320 to the hot water faucet 2200 and is finally outputted from the hot water faucet 2200. When it is necessary to clean the heating tank 6000 and the passageway in communication with the heating tank 6000, the water in the heating tank 6000 may be drained from the heating tank 6000, then flows into the three-way pipe 7000 (flows into the three-way pipe 7000 from the third end 7300), then flows out from the second end 7200 to enter the second drainage passageway 4120, and is drained to the outside through the second drainage passageway 4120.

Since the hot water floats up in the heating tank 6000, the third end 7300 is connected to a bottom of the heating tank 6000. The water entering the heating tank 6000 through the third end 7300 may be sufficiently heated. Based on this, drainage and water feeding of the heating tank 6000 share one opening. Therefore, the three-way pipe 7000 is designed, i.e., the water feeding and drainage of the heating tank 6000 share the third end 7300, simplifying the structure.

Similar to the communication of the cooling tank 5000, the communication of the heating tank 6000 also adopts a connection in an insertion manner. The heating tank 6000 is connected to the first manifold 3000 and the three-way pipe 7000 in an insertion manner. The three-way pipe 7000 is connected to the first manifold 3000 and the second manifold 4000 in an insertion manner. In this way, communication between the second water inlet passageway 3220 and the three-way pipe 7000, communication between the three-way pipe 7000 and the heating tank 6000, communication between the heating tank 6000 and the second water outlet passageway 3320, and communication between the heating tank 6000 and the second drainage passageway 4120 are realized.

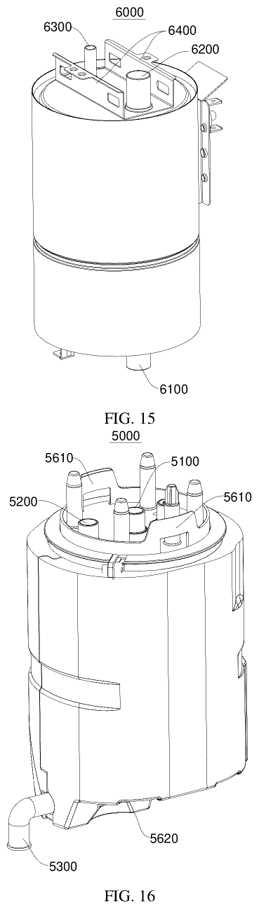

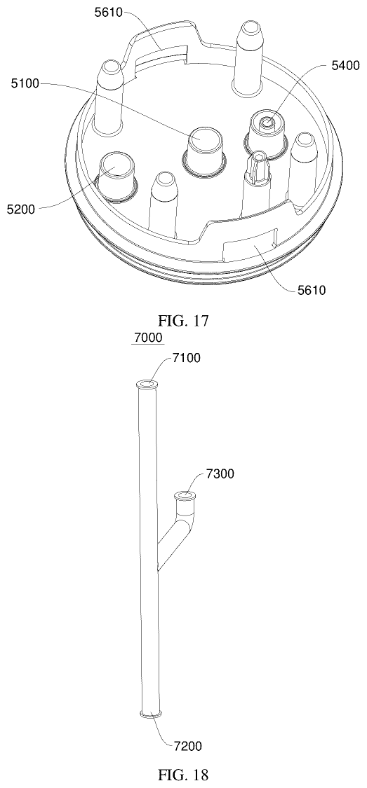

In an exemplary embodiment of the present disclosure, as illustrated in FIG. 6, FIG. 8, FIG. 11, FIG. 15, and FIG. 18, the heating tank 6000 has a heating-tank water outlet connector 6200 and a heating-tank water inlet and drainage connector 6100. The heating-tank water outlet connector 6200 is located at a top of the heating tank 6000. The heating-tank water inlet and drainage connector 6100 is located at the bottom of the heating tank 6000. The heating-tank water outlet connector 6200 and the heating-tank water inlet and drainage connector 6100 are in communication with an internal space of the heating tank 6000, respectively. The second water inlet passageway 3220 has a second water inlet connector 3221 at an end of the second water inlet passageway 3220. Another end of the second water inlet connector 3221 is in communication with the water receiving basin 3100. The second water outlet passageway 3220 has a second water outlet connector 3221 at an end of the second water outlet passageway 3220. Another end of the second water outlet connector 3221 is connected to the hot water faucet 2200. The second drainage passageway 4120 has a second drainage connector 4121 at an end of the second drainage passageway 4120 and has another end in communication with the outside.

When the top-loaded water dispenser is assembled, the second water inlet connector 3221 is connected to the first end 7100 of the three-way pipe 7000 in an insertion manner to communicate the second water inlet passageway 3220 and the three-way pipe 7000, allowing the water to flow from the second water inlet passageway 3220 into the three-way pipe 7000. The heating-tank water inlet and drainage connector 6100 is connected to the third end 7300 of the three-way pipe 7000 in an insertion manner to communicate the three-way pipe 7000 and the heating tank 6000, allowing the water to flow from the three-way pipe 7000 into the heating tank 6000 to be heated into the hot water. The heating-tank water outlet connector 6200 is connected to the second water outlet connector 3321 in an insertion manner to communicate the heating tank 6000 and the hot water faucet 2200, allowing the hot water to flow from the heating tank 6000 to the hot water faucet 2200. The second drainage connector 4121 is connected to the second end 7200 of the three-way pipe 7000 in an insertion manner to communicate the heating tank 6000 and the three-way pipe 7000, allowing the water in the heating tank 6000 to flow to the three-way pipe 7000 (to enter the three-way pipe 7000 from the third end 7300) and then flow to the second drainage passageway 4120 to be drained to the outside.

In some embodiments, the second manifold 4000 further includes an openable member (not shown) that openably closes an end of the first drainage passageway 4110 away from the cooling tank 5000 or an end of the second drainage passageway 4120 away from the heating tank 6000. Under the action of gravity, the drainage passageway (the first drainage passageway 4110 and the second drainage passageway 4120) may be filled with water. When drainage is needed, the one of the end of the first drainage passageway 4110 away from the cooling tank 5000 and the end of the second drainage passageway 4120 away from the heating tank 6000 is opened by the openable member, which can realize a drainage function required by the top-loaded water dispenser. When drainage is not needed, the one of the end of the first drainage passageway 4110 away from the cooling tank 5000 and the end of the second drainage passageway 4120 away from the heating tank 6000 is closed by the openable member, to ensure normal use of the top-loaded water dispenser. It can be understood that a cooling process of the water by the cooling tank 5000 (including a water temperature change and an inflow and outflow of the water) affects an air pressure in the cooling tank 5000, and a heating process of the water by the heating tank 6000 (including the water temperature change and the inflow and outflow of the water) also affects an air pressure in the heating tank 6000. In order to make the cooling tank 5000 and the heating tank 6000 operate normally, as illustrated in FIG. 11, FIG. 15, and FIG. 17, the first manifold 3000 further has an exhaust passage 3400 formed thereon, i.e., the exhaust passage 3400 is integrated on the first manifold 3000 together with the water inlet passageway 3200 and the water outlet passageway 3300. The cooling tank 5000 and the heating tank 6000 are also in communication with the exhaust passage 3400 of the first manifold 3000 other than a waterflow of the first manifold 3000. In this way, balance of an internal air pressure and an external air pressure of the cooling tank 5000 and balance of an internal air pressure and an external air pressure of the heating tank 6000 can be achieved through the exhaust passage 3400, to ensure normal operation of the cooling tank 5000 and the heating tank 6000.

For example, the exhaust passage 3400 includes a first air passage 3410 and a second air passage 3420. The first air passage 3410 is in communication with the cooling tank 5000, allowing the cooling tank 5000 to exhaust air through the first air passage 3410. The second air passage 3420 is in communication with the heating tank 6000, allowing the heating tank 6000 to exhaust the air through the second air passage 3420. Since the cooling tank 5000 and the heating tank 6000 respectively occupy the predetermined space, by providing the first air passage 3410 and the second air passage 3420, the cooling tank 5000 and the heating tank 6000 may be made more flexible in arrangement and exhaust the air without interfering with each other.

Referring to FIG. 10, in some embodiments, the water receiving basin 3100 is internally provided with a first partitioning member 3110 and a second partitioning member 3120. The first partitioning member 3110 is configured to divide the water receiving basin 3100 into a first exhaust region 3130. The first air passage 3410 is in communication with the cooling tank 5000 and the first exhaust region 3130. The second partitioning member 3120 is configured to divide the water receiving basin 3100 into a second exhaust region 3140. The second air passage 3420 is in communication with the heating tank 6000 and the second exhaust region 3140.

In an exemplary embodiment of the present disclosure, the water receiving basin 3100 is internally provided with a first partitioning member 3110 and a second partitioning member 3120. The first partitioning member 3110 may divide the water receiving basin 3100 into the first exhaust region 3130. The first air passage 3410 is in communication with the cooling tank 5000 and the first exhaust region 3130, allowing air in the cooling tank 5000 to flow out through the first air passage 3410 into the first exhaust region 3130. Moreover, the first exhaust region 3130 is divided by the first partitioning member 3110. In this way, an effect of the exhausted from the cooling tank 5000 on the water temperature in the water receiving basin 3100 can be reduced. The second partitioning member 3120 may divide the water receiving basin 3100 into the second exhaust region 3140. The second air passage 3420 is in communication with the heating tank 6000 and the second exhaust region 3140, allowing air in the heating tank 6000 to flow out through the second air passage 3420 into the second exhaust region 3140. Moreover, the second exhaust region 3140 is divided by the second partitioning member 3120. In this way, an effect of the exhausted from the heating tank 6000 on the water temperature in the water receiving basin 3100 can be reduced. Meanwhile, compared with directly exhausting the air to the outside, exhausting the air into the water receiving basin 3100 can effectively prevent an interior of each of the heating tank 6000 and the cooling tank 5000 from being polluted by an external environment, ensuring cleanliness and hygiene, and can ensure a compact structure of the top-loaded water dispenser, which is beneficial to reducing production costs. Further, as illustrated in FIG. 11, FIG. 16, and FIG. 17, in some embodiments, the cooling tank 5000 is adapted to be connected to the first manifold 3000 in an insertion manner, to enable the cooling tank 5000 to be connected to the first air passage 3410. The heating tank 6000 is connected to the first manifold 3000 in an insertion manner, to enable the heating tank 6000 to be connected to the second air passage 3420. In this way, the connection of the cooling tank 5000 and the first air passage 3410 and the connection of the heating tank 6000 and the second air passage 3420 are facilitated in the insertion manner, improving the assembly convenience.

In an exemplary embodiment of the present disclosure, the cooling tank 5000 has a cooling-tank exhaust connector 5400 located at the top of the cooling tank 5000. The first air passage 3410 has a first exhaust connector 3411 at an end of the first air passage 3410 and has another end in communication with the outside. The first exhaust connector 3411 is connected to the cooling-tank exhaust connector 5400 in an insertion manner, to realize the connection between the cooling tank 5000 and the first air passage 3410. The heating tank 6000 has a heating-tank exhaust connector 6300 located at the top of the heating tank 6000. The second air passage 3420 has a second exhaust connector 3421 at an end of the second air passage 3420 and has another end in communication with the outside. The second exhaust connector 3421 is connected to the heating-tank exhaust connector 6300 in an insertion manner, to realize the connection between the heating tank 6000 and the second air passage 3420.

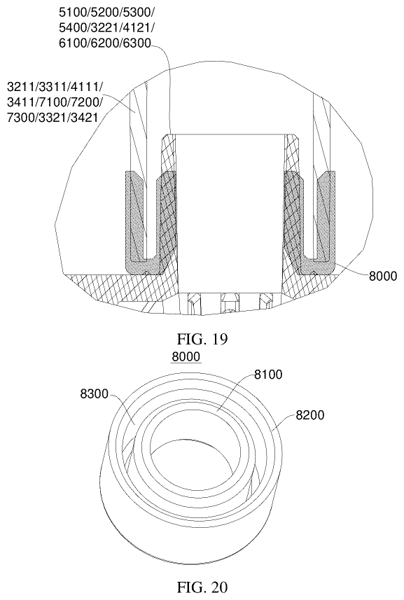

As illustrated in FIG. 19, in some embodiments, a sealing member 8000 is provided between the aforementioned two connected components in the insertion manner to form sealing, i.e., the sealing member 8000 is provided between the cooling-tank water inlet connector 5100 and the first water inlet connector 3211, between the cooling-tank water outlet connector 5200 and the first water outlet connector 3311, between the cooling-tank drainage connector 5300 and the first drainage connector 4111, between the first end 7100 of the three-way pipe 7000 and the second water inlet connector 3221, between the second end 7200 of the three-way pipe 7000 and the second drainage connector 4121, between the third end 7300 of the three-way pipe 7000 and the heating-tank water inlet and drainage connector 6100, between the heating-tank water outlet connector 6200 and the second water outlet connector 3321, between the cooling-tank exhaust connector 5400 and the first exhaust connector 3411, and/or between the heating-tank exhaust connector 6300 and the second exhaust connector 3421.

Further, as illustrated in FIG. 19 and FIG. 20, the sealing member 8000 includes a first annular wall 8100 and a second annular wall 8200 surrounding the first annular wall 8100. The first annular wall 8100 has an end connected to an end of the second annular wall 8200 and another end separated from another end of the second annular wall 8200, to allow an open sandwiched cavity to be defined between the first annular wall 8100 and the second annular wall 8200. It is defined that one of the two connected components in the insertion manner is a first component, and the other one of the two connected components in the insertion manner is a second component. The first component is inserted into the sandwiched cavity 8300, allowing the first annular wall 8100 to be located within the first component and the second annular wall 8200 to be located outside the first component. The second component is inserted into the first component and penetrates the first annular wall 8100. The first annular wall 8100 abuts against the first component and the second component, respectively. In this way, the first annular wall 8100 exists between the first component and the second component to form sealing.

As an example, the cooling-tank water inlet connector 5100 is connected to the first water inlet connector 3211 in an insertion manner. The first water inlet connector 3211 is the first component. The cooling-tank water inlet connector 5100 is the second component. The first water inlet connector 3211 is inserted into the sandwiched cavity 8300. The first annular wall 8100 is located in the first water inlet connector 3211. The second annular wall 8200 is located outside the first water inlet connector 3211. The cooling-tank water inlet connector 5100 is inserted into the first water inlet connector 3211 and penetrates the first annular wall 8100. In this way, the first annular wall 8100 forms sealing between the first water inlet connector 3211 and the cooling-tank water inlet connector 5100.

Continuing in combination with FIG. 19 and FIG. 20, in some embodiments, the first component is in an interference fit with the second annular wall 8200. As the same example, the cooling-tank water inlet connector 5100 is connected to the first water inlet connector 3211 in the insertion manner. The first water inlet connector 3211 is the first component. The cooling- tank water inlet connector 5100 is the second component. The first water inlet connector 3211 is inserted into the sandwiched cavity 8300. Moreover, the second annular wall 8200 is in an interference fit with the first water inlet connector 3211 (the second annular wall 8200 surrounds the first water inlet connector 3211), forming a preliminary positioning and installation effect on the sealing member 8000. A position of the sealing member 8000 is not easy to change, facilitating the insertion of the cooling-tank water inlet connector 5100.

Further, in some embodiments, the first component is in a clearance fit with the first annular wall 8100. Still as the same example, the cooling-tank water inlet connector 5100 is connected to the first water inlet connector 3211 in the insertion manner. The first water inlet connector 3211 is the first component. The cooling-tank water inlet connector 5100 is the second component. The first water inlet connector 3211 is connected to the sandwiched cavity 8300. Moreover, the first annular wall 8100 is in a clearance fit with the first water inlet connector 3211 (the first annular wall 8100 is located in the first water inlet connector 3211). When the cooling-tank water inlet connector 5100 is inserted into the first water inlet connector 3211 and penetrates the first annular wall 8100, the cooling-tank water inlet connector 5100 needs to squeeze the sealing member 8000 (the first annular wall 8100). Therefore, this embodiment is designed with a clearance fit, which provides a predetermined space for deformation of the sealing member 8000 (the first annular wall 8100), to prevent the sealing member 8000 from fracturing under significant compression, realizing effective radial sealing.

As illustrated in FIG. 11 and FIG. 12, in some embodiments, the water outlet passageway 3300 further includes a third water outlet passageway 3330 connected to one of the first water inlet passageway 3210, the second water inlet passageway 3220, and the water receiving basin 3100. In this way, a normal temperature drainage function is realized.

In an exemplary embodiment of the present disclosure, the third water outlet passageway 3330 has an end connected to the one of the first water inlet passageway 3210, the second water inlet passageway 3220, and the water receiving basin 3100, and another end connected to a normal temperature water faucet 2300. In response to an end of the third water outlet passageway 3330 being connected to the water receiving basin 3100, when it is necessary to output normal temperature water, the water in the water receiving basin 3100 directly flows to the normal temperature water faucet 2300 through the third water outlet passageway 3330. In response to an end of the third water outlet passageway 3330 being connected to the second water inlet passageway 3220, when it is necessary to output the normal temperature water, the water in the water receiving basin 3100 flows to the second water inlet passageway 3220, then to the third water outlet passageway 3330, and finally to the normal temperature water faucet 2300 (in this case, a normal temperature water function and a hot water function share the second water inlet passageway 3220). In response to an end of the third water outlet passageway 3330 being connected to the first water inlet passageway 3210, when it is necessary to output the normal temperature water, the water in the water receiving basin 3100 flows to the first water inlet passageway 3210, then to the third water outlet passageway 3330, and finally to the normal temperature water faucet 2300 (in this case, the normal temperature water function and a cold water function share the first water inlet passageway 3210). In this way, a draining temperature of the normal temperature water can be avoided from being affected by the heating tank 6000 and the cooling tank 5000.

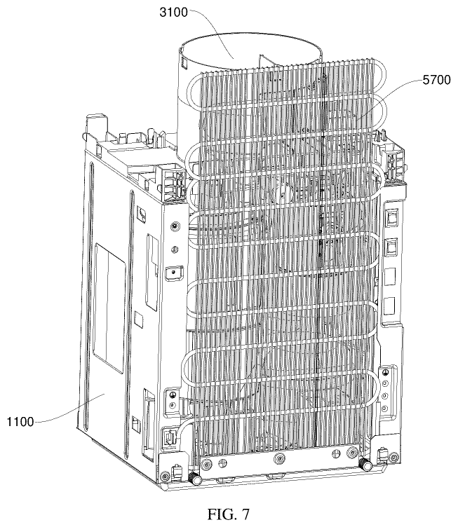

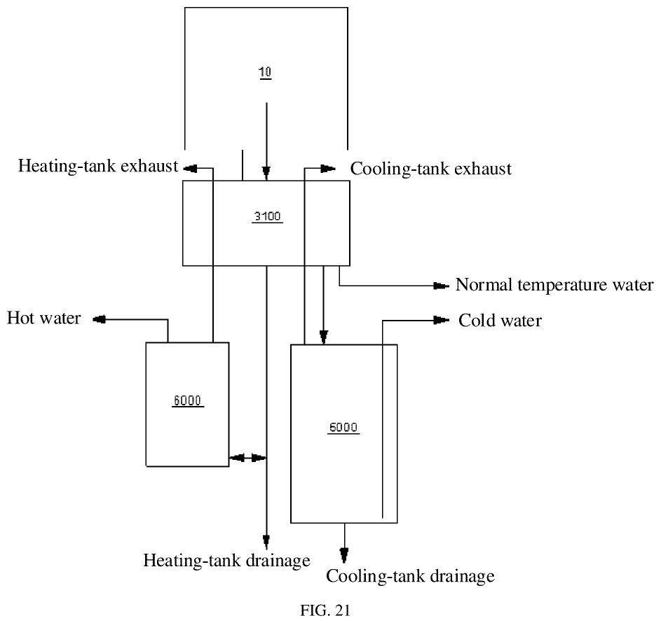

As illustrated in FIG. 6, FIG. 7, FIG. 9, and FIG. 21, in some embodiments, the first manifold 3000 is disposed above the second manifold 4000. The cooling tank 5000 is disposed between the first manifold 3000 and the second manifold 4000. The heating tank 6000 is disposed between the first manifold 3000 and the second manifold 4000. The water receiving basin 3100 is disposed above the water inlet passageway 3200 and the water outlet passageway 3300. In this way, the water (the hot water, cold water, and normal temperature water) can be drained under the action of gravity.

When it is necessary to drain the cold water, the cold water faucet 2100 is turned on. Under the action of gravity, the water in the water bucket 10 enters the water receiving basin 3100, and the water in the water receiving basin 3100 enters the cooling tank 5000 through the first water inlet passageway 3210, and the cooling tank 5000 cools the water entering the cooling tank 5000. As the water continues to enter the cooling tank 5000, the cold water is delivered to the cold water faucet 2100 through the first water outlet passageway 3310 to be drained. When cleaning is required, the first drainage passageway 4110 is opened. Under the action of gravity, the water in the cooling tank 5000 enters the first drainage passageway 4110 to be drained.

When the hot water needs to be drained, the hot water faucet 2200 is turned on. Under the action of gravity, the water in the water bucket 10 enters the water receiving basin 3100, the water in the water receiving basin 3100 enters the three-way pipe 7000 through the second water inlet passageway 3220, the water in the three-way pipe 7000 enters the heating tank 6000, and the heating tank 6000 heats the water entering it. As the water continues to enter the heating tank 6000, the hot water is delivered to the hot water faucet 2200 through the second water outlet passageway 3320. When the cleaning is required, the second drainage passageway 4120 is opened. Under the action of gravity, the water in the heating tank 6000 enters the second drainage passageway 4120 to be drained.

When it is necessary to drain the normal temperature water, the normal temperature water faucet 2300 is turned on. Under the action of gravity, the water in the water bucket 10 enters the water receiving basin 3100, and the water in the water receiving basin 3100 directly enters the third water outlet passageway 3330, or first enters the second water inlet passageway 3220 and then enters the third water outlet passageway 3330, or first enters the first water inlet passageway 3210 and then enters the third water outlet passageway 3330, and is finally delivered to the normal temperature water faucet 2300 to be outputted.

As illustrated in FIG. 6, in some embodiments, the cooling tank 5000 is fixedly connected to the first manifold 3000 and the second manifold 4000, respectively. Since a volume of the cooling tank 5000 is relatively large, the cooling tank 5000 is fixedly connected to the first manifold 3000, and the cooling tank 5000 is fixedly connected to the second manifold 4000, effectively realizing fixation of the cooling tank 5000. Moreover, since the first manifold 3000 is located above the second manifold 4000, the cooling tank 5000 may also support the first manifold 3000 and the second manifold 4000 with this arrangement, improving structural stability. Further, it is worth noting that the cooling tank 5000 needs to be connected to the first manifold 3000 and the second manifold 4000 in an insertion manner, to realize the passageway communication. The cooling tank 5000 is fixedly connected to the first manifold 3000 and the second manifold 4000, respectively. In this way, it is ensured that the cooling tank 5000 and the first manifold 3000 are connected in an insertion manner without being easily separated from each other, and that the cooling tank 5000 and the second manifold 4000 are connected in an insertion manner without being easily separated from each other.

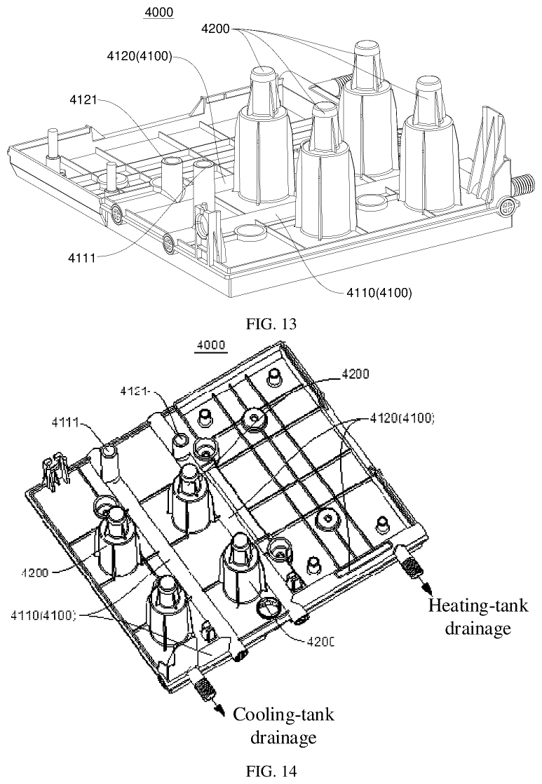

For example, as illustrated in FIG. 12, FIG. 13, and FIG. 16, the first manifold 3000 has a first connection portion 3510. The cooling tank 5000 has a third connection portion 5610. The first connection portion 3510 is fixedly connected to the third connection portion 5610, realizing that the cooling tank 5000 is fixedly connected to the first manifold 3000. The second manifold 4000 has a second connection portion 4200. The cooling tank 5000 has a fourth connection portion 5620. The second connection portion 4200 is fixedly connected to the fourth connection portion 5620, realizing that the cooling tank 5000 is fixedly connected to the second manifold 4000. The connection and fixation of the first connection portion 3510 and the third connection portion 5610, and the connection and fixation of the second connection portion 4200 and the fourth connection portion 5620 are achieved in various manners, such as by welding, riveting, snap-fitting, or screwing. The first connection portion 3510 and the second connection portion 4200 may be snap holes, the third connection portion 5610 and the fourth connection portion 5620 may be snaps, and the snap holes and the snaps allow for a snap-fit connection. Alternatively, the first connection portion 3510 and the second connection portion 4200 may be fastener holes, and the third connection portion 5610 and the fourth connection portion 5620 may also be fastener holes, allowing for connections by threading a threaded fastener. In other embodiments of the present disclosure, other connection manners may also be used as long as the required connection and fixation are achieved in these connection manners.

As illustrated in FIG. 6, in some embodiments, the heating tank 6000 is fixedly connected to the first manifold 3000. Since a size of the heating tank 6000 is smaller than a size of the cooling tank 5000, support for the heating tank 6000 may also be realized by fixedly connecting the heating tank 6000 to the first manifold 3000.

For example, the first manifold 3000 has a fifth connection portion 3520. The heating tank 6000 has a sixth connection portion 6400. The fifth connection portion 3520 is fixedly connected to the sixth connection portion 6400. The fifth connection portion 3520 and the sixth connection portion 6400 are connected in various manners, such as by welding, riveting, snapping, and screwing. The fifth connection portion 3520 may be a snap, the sixth connection portion 6400 may be a snap hole, and the snap and the snap hole may be snap-fitted together. Alternatively, the fifth connection portion 3520 may be a fastening hole, the sixth connection portion 6400 may be a fastening hole, and the fifth connection portion 3520 and the sixth connection portion 6400 may be fastened by threading a threaded fastener. In other embodiments of the present disclosure, other connection manners may also be used.

As illustrated in FIG. 12 and FIG. 15, in some embodiments, the top-loaded water dispenser further includes a compressor 5500. The compressor 5500 is in refrigerant communication with the cooling tank 5000. It can be understood that the refrigerant communication means that the cooling tank 5000 requires refrigerant circulation provided by the compressor 5500 to realize water refrigeration (the cooling tank 5000 and the compressor 5000 form a part of a refrigerant circulation system), which can refer to the related technology without detailed description here. Since the heating tank 6000 is fixedly connected to the first manifold 3000, the heating tank 6000 is designed to be spaced apart from the second manifold 4000. The compressor 5500 is placed below the heating tank 6000 and fixedly connected to the second manifold 4000, allowing the compressor 5500 to be located between the heating tank 6000 and the second manifold 4000. In this way, each component is more compact in arrangement to reduce its space occupation as much as possible.

As illustrated in FIG. 5 to FIG. 9, in some embodiments, the top-loaded water dispenser includes a housing 1000 and a support 1100. The housing 1000 is an outer structure of the top-loaded water dispenser and shields and protects internal parts of the top-loaded water dispenser. The support 1100 is a structure for mounting the first manifold 3000 and the second manifold 4000. The first manifold 3000 and the second manifold 4000 are fixedly connected onto the support 1100. The cooling tank 5000 is fixedly connected to the first manifold 3000 and the second manifold 4000, the heating tank 6000 is fixedly connected to the first manifold 3000, and the compressor 5500 is fixedly connected to the second manifold 4000. Therefore, the support 1100 allows for assembly of a modular design (including that a condenser 5700 of the top-loaded water dispenser may also be mounted on the support 1100), facilitating installation within the housing 1000.

As illustrated in FIG. 1 to FIG. 4, in some embodiments, the top-loaded water dispenser includes a housing 1000, a support 1100, and a functional module. The functional module is located in the housing 1000 and includes the first manifold 3000, the second manifold 4000, the cooling tank 5000, and the heating tank 6000. The functional module is integrally disposed on the support 1100. The support 1100 is connected to the housing 1000.

The functional module is located in the housing 1000. The functional module may be protected by the housing 1000 to avoid damage caused by the external structure to the functional module, which is beneficial to prolonging a service life of the top-loaded water dispenser and ensuring a beautiful appearance. The functional module may also include the compressor 5500, the condenser 5700, and the like, other than the first manifold 3000, the second manifold 4000, the cooling tank 5000, and the heating tank 6000. The functional module is integrally disposed on the support 1100, and the support 1100 is connected to the housing 1000, which can realize a connection between the functional module and the housing 1000, ensuring that the functional module is reliably fixed in the housing 1000. Moreover, the functional module may be collectively installed on the support 1100. Then, the functional module and the support 1100 are integrally installed in the housing 1000. In this way, it is convenient to realize integral installation of the functional module, and is beneficial to realizing mechanical automation production, improving the production efficiency. In addition, a function precheck can be performed on the integrated functional module to avoid problems such as disassembly and rework needs after the installation of the top-loaded water dispenser is completed.

Meanwhile, the functional module may be formed as a basic definition platform, which facilitates expansion of the housing 1000 in shape and color, can realize production of top-loaded water dispensers with different appearances, is conducive to improving a structural universality rate and an automation coverage rate, and can reduce man-hours and the production costs. In some embodiments, the structure of the functional module (such as the cooling tank 5000 and the heating tank 6000) can be selectively configured in specification as different requirements, which can realize production of top-loaded water dispensers with different performances, satisfying different use requirements.

As illustrated in FIG. 1 to FIG. 4, the housing 1000 includes a body 1001 and a bottom plate 1002. The body 1001 is connected to the bottom plate 1002 at a lower end of the body 1001. A mounting cavity is defined between the body 1001 and the bottom plate 1002. The functional module is located in the mounting cavity and spaced apart from the bottom plate 1002. The body 1001 includes an upper cover 1010, a first side plate 1020, a second side plate 1030, and a front housing 1040. The upper cover 1010 has an avoidance hole 1011 for installing the water bucket 10. Each of two ends of the first side plate 1020 in a length direction (up-down direction) of the first side plate 1020 and two ends of the second side plate 1030 in a length direction (up-down direction) of the second side plate 1030 are connected to the upper cover 1010 and the bottom plate 1002, respectively. Moreover, the first side plate 1020 and the second side plate 1030 are located at two opposite sides of the bottom plate 1002, respectively. The front housing 1040 is located at one side of the first side plate 1020 in a width direction (front-rear direction) of the first side plate 1020 and the second side plate 1030 in a width direction (front-rear direction) of the second side plate 1030. The front housing 1040 is connected to each of the first side plate 1020, the second side plate 1030, and the upper cover 1010. The front housing 1040 is opposite to the functional module and is spaced apart from the bottom plate 1002. In this way, an integral frame can be formed by the housing 1000, which is beneficial to improving a structural strength of the housing 1000, ensuring reliable protection of the functional module by the housing 1000, and extending the service life of the top-loaded water dispenser.

In another exemplary embodiment of the present disclosure, as illustrated in FIG. 1 to FIG. 4, in some embodiments, the body 1001, the bottom plate 1002, and the functional module together define a storage space 1003 opened at a front side of the storage space 1003. The storage space 1003 is internally provided with a partition 1004 spaced apart from each of the bottom plate 1002 and the functional module. For example, each of the functional module and the front housing 1040 is spaced apart from the bottom plate 1002. The first side plate 1020, the second side plate 1030, the bottom plate 1002, and the functional module together define a storage space 1003, which can be used to store sundries such as teacups and disposable paper cups, making it convenient for the user to take and place required tools when drinking water and enhancing a user's usage experience. The arrangement of the partition 1004 may divide the storage space 1003 into an upper sub-space and a lower sub-space. In this way, the user can freely choose whether to place the sundries in the upper sub-space or the lower sub-space, improving a space utilization rate of the storage space 1003 and avoiding a space waste.

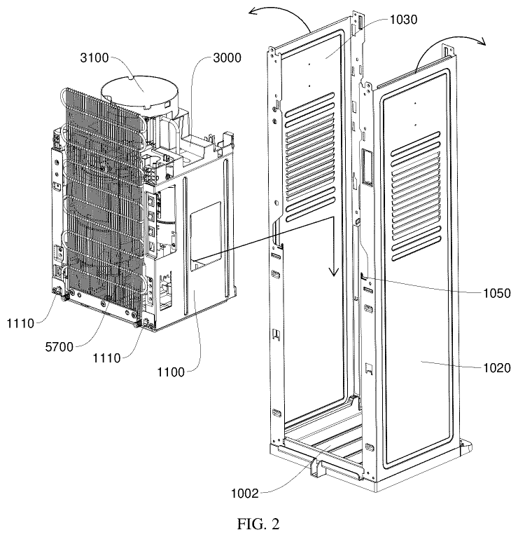

It should be noted that, in some embodiments, as illustrated in FIG. 2, when the housing 1000 and the functional module are assembled, the first side plate 1020 and the second side plate 1030 are connected by the bottom plate 1002. A relative positional relationship between the first side plate 1020 and the second side plate 1030 may be maintained by the bottom plate 1002, which can improve structural stability of the housing 1000. The functional module is placed into the housing 1000 through upper ends of the first side plate 1020 and the second side plate 1030. A distance between the upper ends of the first side plate 1020 and the second side plate 1030 becomes larger, making the first side plate 1020 and the second side plate 1030 in an assembled state. In this way, an installation channel for the functional module that gradually widens from bottom to top can be formed. Therefore, it is possible to reduce difficulty of placing the functional module between the first side plate 1020 and the second side plate 1030 from top to bottom, and it is beneficial to improving assembly efficiency of the functional module and the housing 1000. Further, after the assembly of the housing 1000 and the functional module is completed, the functional module is placed in the housing 1000 and connected to the housing 1000. A distance between the first side plate 1020 and the second side plate 1030 is unchanged in an up-down direction. In this way, it is ensured that the functional module is reliably fixed.

The relative positional relationship between the first side plate 1020 and the second side plate 1030 in the assembled state may be realized by a swing mechanism. For example, lower ends of the first side plate 1020 and the second side plate 1030 are connected to the bottom plate 1002 by their corresponding swing mechanisms, respectively. The first side plate 1020 may swing away from the second side plate 1030 relative to the bottom plate 1002 by its corresponding swing mechanism, and the second side plate 1030 may swing away from the first side plate 1020 relative to the bottom plate 1002 by its corresponding swing mechanism, to ensure that the distance between the first side plate 1020 and the second side plate 103 gradually increase from bottom to top. Alternatively, the relative positional relationship between the first side plate 1020 and the second side plate 1030 in the assembled state may be directly realized by applying a force to the upper ends of the first side plate 1020 and the second side plate 1030 to push the first side plate 1020 and the second side plate 1030 away from each other, making slight deformations of the first side plate 1020 and the second side plate 1030. A manner where the first side plate 1020 and the second side plate 1030 are switched to the assembled state is not specifically limited here.

As illustrated in FIG. 1 to FIG. 4, in some embodiments, the top-loaded water dispenser further includes an openable/closable door 1300 disposed at the front side of the storage space 1003 and arranged in the up-down direction with the front housing 1040. One of two opposite ends of the openable/closable door 1300 is rotatably connected to the body 1001 or the bottom plate 1002, to open or close the storage space 1003. It can be understood that when the openable/closable door 1300 opens the storage space 1003, the user may take things from the storage space 1003 or put things into the storage space 1003, to satisfy user's storage needs. When the openable/closable door 1300 closes the storage space 1003, the dust, sundries, and the like may be prevented from entering the storage space 1003, to reduce a cleaning frequency of the storage space 1003. Moreover, the sundries placed in the storage space 1003 may be blocked, and an aesthetic degree of the top-loaded water dispenser may be greatly improved. In another exemplary embodiment of the present disclosure, one of two ends of the openable/closable door 1300 in a horizontal direction may be rotatably connected to the first side plate 1020 or the second side plate 1030, or a lower end of the openable/closable door 1300 may be rotatably connected to the bottom plate 1002.

In some embodiments, the support 1100 is in a snap-fit connection with the housing 1000 to ensure that the support 1100 is reliably fixed on the housing 1000. In this way, it is ensured that the functional module is reliably fixed in the housing 1000, which avoids problems such as shaking of the functional module in the housing 1000 and facilitates assembly. In this way, it is beneficial to improving assembly efficiency.

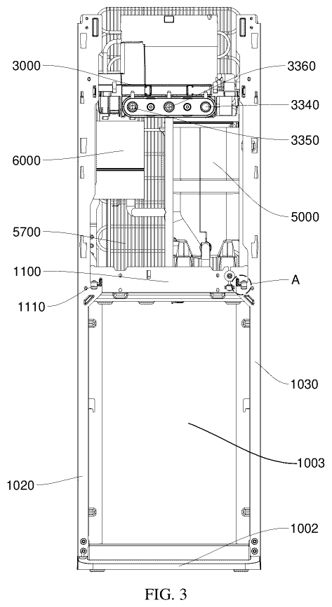

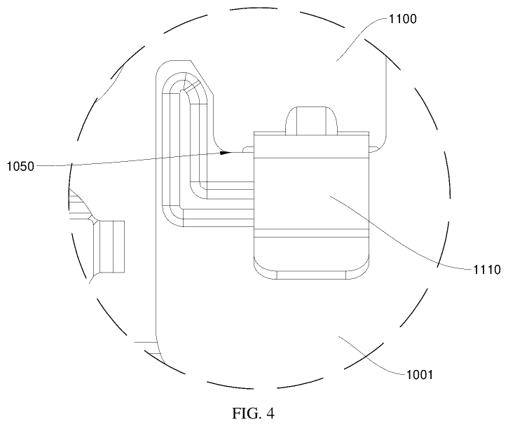

In some embodiments, as illustrated in FIG. 3 and FIG. 4, the support 1100 is provided with a hook 1110, the housing 1000 has a hook slot 1050 defined thereon, and the hook 1110 cooperates with the hook slot 1050. Therefore, by cooperating the hook 1110 with the hook slot 1050, it can be ensured that the support 1100 is fixed on the housing 1000, and pre-position can be achieved. In addition, quick positioning and mounting of the support 1100 and the housing 1000 can be ensured, which is beneficial to improving the assembly efficiency.

In some embodiments, a plurality of hooks 1110 may be provided. The plurality of hooks 1110 are arranged at intervals on the support 1100. A plurality of hook slots 1050 may be provided. The plurality of hook slots 1050 cooperate with the plurality of hooks 1110. In this way, guiding and positioning of the support 1100 and the housing 1000 at different positions can be realized through cooperation of the hook slots 1050 and the hooks 1110 at different positions in one-to-one correspondence, further improving assembly accuracy of the support 1100 and the housing 1000, which is beneficial to improving the assembly efficiency.

In some embodiments, the support 1100 and the housing 1000 are connected by a fastener to ensure that the support 1100 and the housing 1000 are reliably connected. In this way, the support 1100 is reliably fixed on the housing 1000, ensuring that the functional module is reliably fixed on the housing 1000 and allowing for easy disassembly, facilitating maintenance or replacement. Therefore, the production costs can be reduced. For example, the fastener may be a screw or the like. There may be a plurality of fasteners (two or more fasteners). Fixing of the support 1100 and the housing 1000 at a plurality of different positions can be realized through the plurality of fasteners, to ensure that the support 1100 and the housing 1000 are reliably fixed.

As illustrated in FIG. 1 and FIG. 5, in some embodiments, the housing 1000 has a through hole 1005 formed at a front side of the housing 1000. The top-loaded water dispenser further includes a water outlet member adapted to pass through the through hole 1005 to be connected to the first manifold 3000 and be in communication with a water outlet of the first manifold 3000. The water may be controlled by the water outlet member to flow out from the first manifold 3000 through the water outlet member to satisfy required drainage demands. For example, when the user needs to receive the water, the water outlet member may be opened, allowing the water in the first manifold 3000 to flow out from the water outlet member through the water outlet of the first manifold 3000. When the user finishes receiving the water, the water outlet member may be closed to prevent the water from flowing out from the water outlet member. It can be understood that the water outlet of the first manifold 3000 includes, but is not limited to, a first water outlet 3340 of the first water outlet passageway 3310, a second water outlet 3350 of the second water outlet passageway 3320, or a third water outlet 3360 of the third water outlet passageway 3330. The water outlet member includes, but is not limited to, the cold water faucet 2100, the hot water faucet 2200, or the normal temperature water faucet 2300.

In some embodiments, the water outlet member is detachably connected to the first manifold 3000. In this way, detachable communication between the water outlet member and the water outlet of the first manifold 3000 is realized, which can facilitate maintenance and replacement of the water outlet member when water leakage or other problems occur in the water outlet member, reduce maintenance difficulty of the top-loaded water dispenser, and shorten a maintenance time of the top-loaded water dispenser.

In some embodiments, as illustrated in FIG. 1 and FIG. 5, the top-loaded water dispenser further includes a water collection box 1400. The water collection box 1400 is disposed at the front side of the housing 1000 and located below the water outlet member, and the water outlet member has an outlet. It can be understood that during water receiving by using the top-loaded water dispenser, in response to a water cup being not aligned with the outlet of the water outlet member, water flowing out from the outlet may flow into the water collection box 1400. Alternatively, when the water cup is already full of water, and when the user does not notice it in time, any overflow of water from the water cup may also flow into the water collection box 1400. The arrangement of the water collection box 1400 allows for temporary water storage, to prevent the water flowing out from the outlet of the water outlet member from spilling onto the ground, avoiding occurrence of ground slippery, pedestrian slipping, and other situations.

Further, a distance between the outlet of the water outlet member and the water collection box 1400 in the up-down direction is a and satisfies: 227 mm≤a≤233 mm. It can be understood that the user often has a habit of placing the water cup on the water collection box 1400 when receiving water with the water cup. However, in the related technology, the distance between the water collection box 1400 and the outlet of the water outlet member generally ranges from 150 mm to 190 mm. When the user uses a high water cup with a height greater than 200 mm, the user is unable to place the high water cup on the water collection box 1400. Therefore, the user needs to hold the high water cup to receive the water, which reduces the user's usage experience. In this embodiment, the distance a between the outlet of the water outlet member and the water collection box 1400 satisfies 227 mm≤a≤233 mm, which can increase the distance a between the outlet of the water outlet member and the water collection box 1400. In this way, when the user uses the top-loaded water dispenser, whether the user is using a lower water cup or a higher one, the water cup can be better placed on the water collection box 1400 without interference from the water outlet member, which can better free user's hands, enhancing the user's usage experience and comfort. For example, the distance a between the outlet of the water outlet member and the water collection box 1400 may be 227 mm, 229 mm, 230 mm, 231 mm, or 233 mm.

The foregoing is merely a preferred embodiment of the present disclosure, and is not therefore intended to limit the scope of the present disclosure. Any equivalent structural modification made by using the specification and drawings of the present disclosure, or directly/indirectly applied in other related technical fields, are all fall within the scope of the of the present disclosure under the concept of the present disclosure.

What is claimed is:

1. A top-loaded water dispenser, comprising:
a first manifold having a water receiving basin, a water inlet passageway, and a water outlet passageway;
a second manifold having a drainage passageway;
a cooling tank adapted to be in communication with the water inlet passageway to receive water from the water receiving basin, adapted to be in communication with the water outlet passageway to output refrigerated water, and further adapted to be in communication with the drainage passageway to drain the water in the cooling tank; and
a heating tank adapted to be in communication with the water inlet passageway to receive the water from the water receiving basin, adapted to be in communication with the water outlet passageway to output heated water, and further adapted to be in communication with the drainage passageway to drain the water in the heating tank.

2. The top-loaded water dispenser according to claim 1, wherein:
the water inlet passageway comprises a first water inlet passageway and a second water inlet passageway that are in communication with the water receiving basin;
the water outlet passageway comprises a first water outlet passageway and a second water outlet passageway;
the drainage passageway comprises a first drainage passageway and a second drainage passageway;
the cooling tank is adapted to be in communication with the first water inlet passageway to receive the water from the water receiving basin, adapted to be in communication with the first water outlet passageway to output the refrigerated water, and further adapted to be in communication with the first drainage passageway to drain the water in the cooling tank; and
the heating tank is adapted to be in communication with the second water inlet passageway to receive the water from the water receiving basin, adapted to be in communication with the second water outlet passageway to output the heated water, and further adapted to be in communication with the second drainage passageway to drain the water in the heating tank.

3. The top-loaded water dispenser according to claim 2, wherein the cooling tank is connected to the first manifold and the second manifold in an insertion manner.

4. The top-loaded water dispenser according to claim 2, wherein:
the first water inlet passageway has a first water inlet connector at an end of the first water inlet passageway;
the first water outlet passageway has a first water outlet connector at an end of the first water outlet passageway;
the first drainage passageway has a first drainage connector at an end of the first drainage passageway; and
the cooling tank has a cooling-tank water inlet connector connected to the first water inlet connector in an insertion manner, a cooling-tank water outlet connector connected to the first water outlet connector in an insertion manner, and a cooling-tank drainage connector connected to the first drainage connector in an insertion manner.

5. The top-loaded water dispenser according to claim 2, further comprising a three-way pipe, wherein the three-way pipe has an end in communication with the second water inlet passageway, another end in communication with the second drainage passageway, and a remaining end in communication with the heating tank.

6. The top-loaded water dispenser according to claim 5, wherein:
the heating tank is connected to the first manifold and the three-way pipe in an insertion manner; and
the three-way pipe is connected to the first manifold and the second manifold in an insertion manner.

7. The top-loaded water dispenser according to claim 5, wherein:
the second water inlet passageway has a second water inlet connector at an end of the second water inlet passageway;
the second water outlet passageway has a second water outlet connector at an end of the second water outlet passageway;
the second drainage passageway has a second drainage connector at an end of the second drainage passageway;
the heating tank has a heating-tank water inlet and drainage connector and a heating-tank water outlet connector; and
the three-way pipe has an end connected to the second water inlet connector in an insertion manner, another end connected to the second drainage connector in an insertion manner, and a remaining end connected to the heating-tank water inlet and drainage connector in an insertion manner, the heating-tank water outlet connector being connected to the second water outlet connector in an insertion manner.

8. The top-loaded water dispenser according to claim 2, wherein the second manifold further comprises an openable member, the openable member openably closing an end of the first drainage passageway away from the cooling tank or an end of the second drainage passageway away from the heating tank.

9. The top-loaded water dispenser according to claim 1, wherein the first manifold further has an exhaust passage, each of the cooling tank and the heating tank being further adapted to be in communication with the exhaust passage for exhausting.

10. The top-loaded water dispenser according to claim 9, wherein the exhaust passage comprises a first air passage and a second air passage, the cooling tank being adapted to be in communication with the first air passage for exhausting, and the heating tank being adapted to be in communication with the second air passage for exhausting.

11. The top-loaded water dispenser according to claim 10, wherein:
the water receiving basin is internally provided with a first partitioning member and a second partitioning member;
the first partitioning member is configured to divide the water receiving basin into a first exhaust region, the first air passage being in communication with the cooling tank and the first exhaust region; and
the second partitioning member is configured to divide the water receiving basin into a second exhaust region, the second air passage being in communication with the heating tank and the second exhaust region.

12. The top-loaded water dispenser according to claim 10, wherein:
the cooling tank is connected to the first manifold in an insertion manner, to enable the cooling tank to in communication with the first air passage; and/or
the heating tank is connected to the first manifold in an insertion manner, to enable the heating tank to be in communication with the second air passage.

13. The top-loaded water dispenser according to claim 10, wherein:
the first air passage has a first exhaust connector at an end of the first air passage, and the cooling tank has a cooling-tank exhaust connector connected to the first exhaust connector in an insertion manner; and/or
the second air passage has a second exhaust connector at an end of the second air passage, and the heating tank has a heating-tank exhaust connector connected to the second exhaust connector in an insertion manner.

14. The top-loaded water dispenser according to claim 3, wherein a sealing member is provided between the components connected in the insertion manner for sealing.

15. The top-loaded water dispenser according to claim 2, wherein the water outlet passageway further comprises a third water outlet passageway connected to one of the water receiving basin, the first water inlet passageway, and the second water inlet passageway.

16. The top-loaded water dispenser according to claim 1, wherein:
the water receiving basin is located above the water inlet passageway and the water outlet passageway;
the first manifold is located above the second manifold; and
the cooling tank and the heating tank are disposed between the first manifold and the second manifold.

17. The top-loaded water dispenser according to claim 16, wherein the cooling tank is fixedly connected to the first manifold and the second manifold, respectively.

18. The top-loaded water dispenser according to claim 17, wherein:
the first manifold has a first connection portion;
the second manifold has a second connection portion; and
the cooling tank has a third connection portion fixedly connected to the first connection portion, and a fourth connection portion fixedly connected to the second connection portion.

19. The top-loaded water dispenser according to claim 16, wherein the heating tank is fixedly connected to the first manifold and spaced apart from the second manifold.

20. The top-loaded water dispenser according to claim 1, further comprising a smart base disposed in the water receiving basin, the smart base being adapted for an inverted loading of a water bucket on the smart base.
